(19) United States
(12) Patent Application Publication
(10) Pub. No.: US 2026/0202676 A1
(43) Pub. Date: Jul. 16, 2026

(54) DETERMINING A PREDICTED COMFORT SCORE FOR A HEAD MOUNTED DEVICE

(71) Applicant: GOOGLE LLC, Mountain View, CA (US)

(72) Inventors: Idris Syed Aleem, Kitchener (CA); Dongeek Shin, San Jose, CA (US); Philip Lindsley Davidson, Arlington, MA (US); Zhiheng Jia, Sunnyvale, CA (US)

(21) Appl. No.: 19/138,517

(22) PCT Filed: Dec. 15, 2022
(86) PCT No.: PCT/US2022/081674

§ 371 Date: Jun. 12, 2025

(51) Int. Cl. G02B 27/01; G06V 40/16

(52) U.S. Cl. CPC G02B 27/0176; G06V 40/168; G02B 27/017; G02B 2027/0178

(57) ABSTRACT

A device may receive a first indication that a head mounted device is being worn by a user, the head mounted device including a headset comprising a front frame portion connected to a first arm portion and a second arm portion, receiving a first measurement from a sensor indicating an arm portion to skin distance, receiving a second measurement from a inertial measurement unit indicating an arm portion orientation, executing a comfort prediction model using the first measurement and the second measurement as inputs to generate a predicted comfort score; and generating a second indication to display a headset fit instruction based on the predicted comfort score.

### FIELD

This document relates, generally, to predicting a comfort score for a head mounted device, and in particular to using a machine learning model to predict a comfort score for a head mounted device.

### BACKGROUND

Head mounted devices include headsets and supporting electronics that operate augmented reality, virtual reality, or mixed-reality applications. Typically, head mounted devices come in limited frame styles and sizes. Users often order head mounted devices online or in other circumstances where they are not able to try on before purchasing. If a head mounted device is not comfortable, users will not be able to wear it for long, severely limiting its usefulness.

### SUMMARY

The present disclosure describes methods to predict whether a user will find a head mounted device, such as an augmented reality or virtual reality headset, to be comfortable to wear or not. The disclosure describes using proximity or capacitance sensor measurement correlating to a skin to frame distance and an inertial measurement unit measurement as input to a machine learning model, which outputs a predicted comfort score. Other possible inputs are described as well, including additional inertial measurement unit input, a pressure measurement input, and information about a facial feature of the user. Based on the predicted comfort score, the disclosure further describes displaying a headset fit instruction to the user.

In some aspects, the techniques described herein relate to a method including, receiving a first indication that a head mounted device is being worn by a user, the head mounted device including a headset including a front frame portion connected to a first arm portion and a second arm portion; receiving a first measurement from a sensor indicating an arm portion to skin distance; receiving a second measurement from a inertial measurement unit indicating an arm portion orientation; executing a comfort prediction model using the first measurement and the second measurement as inputs to generate a predicted comfort score; and generating a second indication to display a headset fit instruction based on the predicted comfort score. With respect to the comfort prediction model, the predicted comfort score.

In some aspects, the techniques described herein relate to a head mounted device including: a headset including a front frame portion connected to a first arm portion and a second arm portion; a sensor operable to provide a first measurement indicating an arm portion to skin distance; an inertial measurement unit operable to provide a second measurement indicating an arm portion orientation; a memory; and a processing circuitry coupled to the memory, the processing circuitry being configured to: receive a first indication that the headset is being worn by a user, receive the first measurement, receive the second measurement, execute a comfort prediction model using the first measurement and the second measurement as inputs to generate a predicted comfort score, and generate a second indication to display a headset fit instruction based on the predicted comfort score.

In some aspects, the techniques described herein relate to a system including: a comfort prediction initiation module configured to receive a first indication that a headset is being worn by a user, the headset including a front frame portion connected to a first arm portion and a second arm portion; a data receiving module configured to receive a first measurement from a sensor indicating an arm portion to skin distance, and a second measurement from an inertial measurement unit sensor indicating an arm portion orientation; a comfort prediction module configured to execute a comfort prediction model using the first measurement and the second measurement as inputs to generate a predicted comfort score; and a headset fit instruction module configured to generate a second indication to display a headset fit instruction based on the predicted comfort score.

### BRIEF DESCRIPTION OF THE DRAWINGS

FIG. 1A depicts a head mounted device worn by a user, according to an example.

FIG. 1B depicts a front view of a head mounted device, according to an example.

FIG. 1C depicts a rear view of a head mounted device, according to an example.

FIG. 1D is a top view of a head mounted device in a neutral position, according to an example.

FIG. 1E is a top view of a head mounted device in a hyperextended position, according to an example.

FIG. 2 depicts a block diagram of an example head mounted device.

FIG. 3 depicts a flow chart of method 300, which may be used to generate a predicted comfort score for a headset, according to an example.

### DETAILED DESCRIPTION

This disclosure relates to generating a predicted comfort score for a head mounted device. Head mounted devices are glasses or headsets that include electronics to support eye tracking, position sensing, displays, and other functions. Head mounted devices are often purchased online or boxed in a store without opportunities to try them on first. Because head mounted devices integrate various electronics and optics, they are sometimes heavier than normal glasses, and often come in limited sizes and styles. Moreover, they are seldom purchased or unboxed with the help of an optician to assess and adjust the fit.

There are many reasons that a headset or glasses may be uncomfortable to a user. For example, when a headset applies too much pressure to the head of a user, the user can get a headache in response. In other examples, the electronics inside the head mounted device may emit heat which a user may find to be uncomfortable. In other examples, a head mounted device might be too large to stay in place on a user's head, causing the user to tension facial muscles to retain the head mounted device in place. In these examples and others where a head mounted device does not fit a user's head optimally, the user is less likely to use and gain the benefit of the technology.

Determining whether a head mounted device is uncomfortable or not is complicated by the fact that the user may not be able to assess the comfort level initially at first try on. The reason is that sometimes it takes some time to feel the effects of pressure or heat, especially around the head and temple areas. It may take 30 minutes or an hour to feel a headache that may also come on slowly, for example. By the time the user finally feels the headache or other pay, the user may not associate the pain with the head mounted device.

Consciously or unconsciously, the user may stop using the head mounted device and/or develop an aversion to using the head mounted device that will deter the user from seeking a better fit. What is needed is a way to predict whether the head mounted device is likely to be uncomfortable at the first moment that the user tries it on.

In accordance with the implementations described herein, a technical solution to the above-described technical problem includes determining that a head mounted device is being worn by a user, receiving a first measurement indicating an arm portion to skin distance, receiving a second measurement indicating an arm portion orientation, and executing a comfort prediction model using the first measurement and the second measurement as inputs to generate a predicted comfort score. An indication may then be generated to display a headset fit instruction based on the predicted comfort score.

In examples, this method may be performed as part of an unboxing exercise, when a user opens a new head mounted device for the first time and seeks to determine if the head mounted device is comfortable or fits correctly.

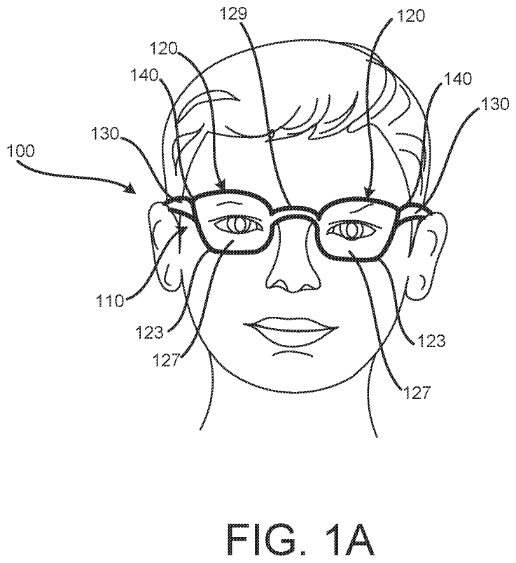

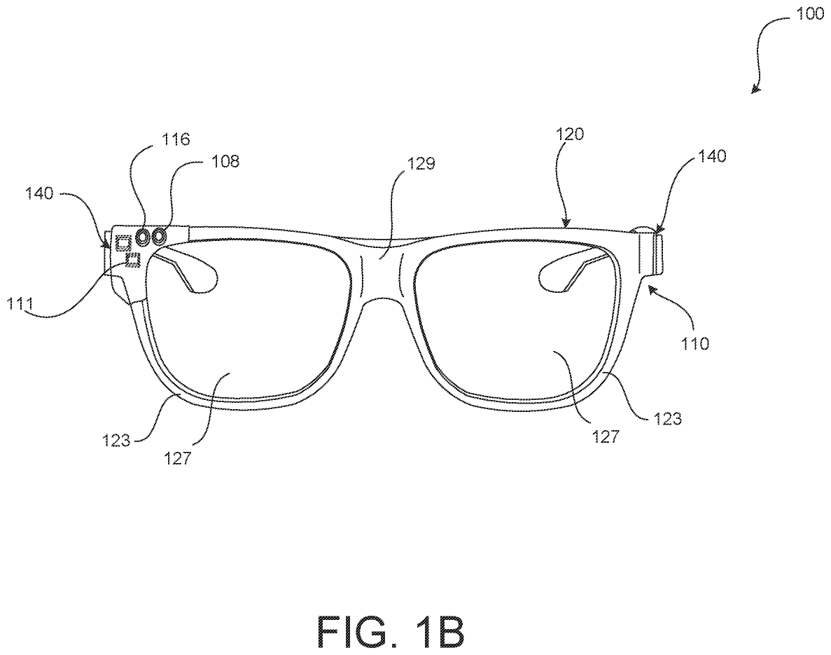

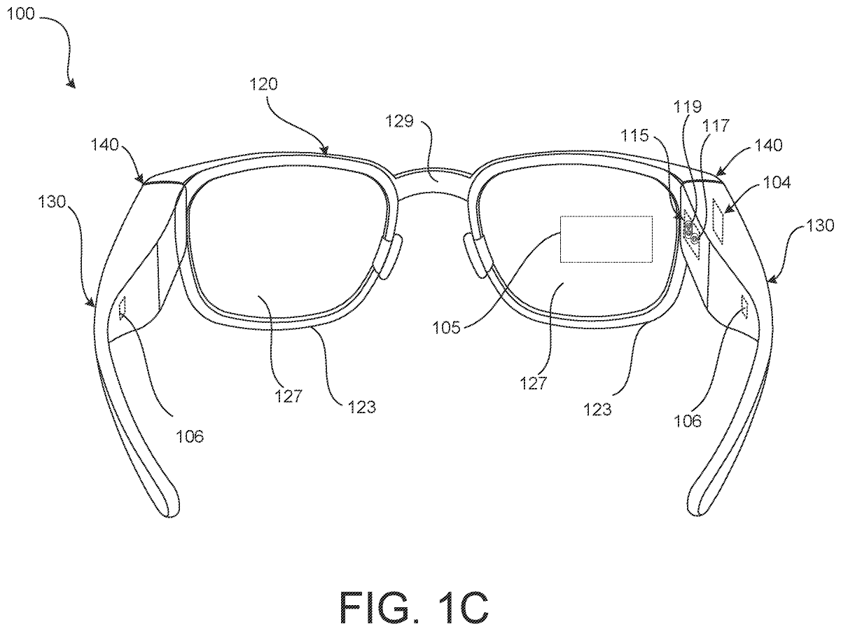

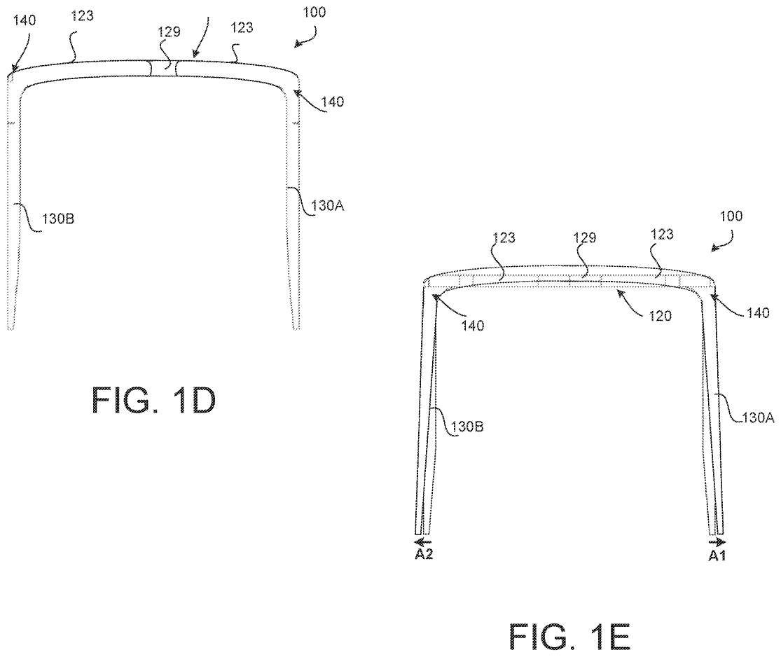

FIG. 1A illustrates a user wearing an example head mounted device 100 in the form of smart glasses, or augmented reality glasses, including display capability, eye/gaze tracking capability, and computing/processing capability. FIG. 1B depicts a front view, and FIG. 1C depicts a rear view, of the example head mounted device 100 shown in FIG. 1A. The example head mounted device 100 includes a headset 110. The headset 110 includes a front frame portion 120, and a pair of arm portions 130 rotatably coupled to the front frame portion 120 by respective hinge portions 140. The front frame portion 120 includes rim portions 123 surrounding respective optical portions in the form of lenses 127, with a bridge portion 129 connecting the rim portions 123. The arm portions 130 are coupled, for example, pivotably or rotatably coupled, to the front frame portion 120 at peripheral portions of the respective rim portions 123. In some examples, the lenses 127 are corrective/prescription lenses. In some examples, the lenses 127 are an optical material including glass and/or plastic portions that do not necessarily incorporate corrective/prescription parameters.

In some examples, the head mounted device 100 includes a display 104 that can output visual content, for example, at an output coupler 105, so that the visual content is visible to the user. In the example shown in FIGS. 1B and 1C, the display 104 is provided in one of the arm portions 130, simply for purposes of discussion and illustration. A display 104 may be provided in each of the arm portions 130 to provide for binocular output of content. In some examples, the display 104 may be a see-through near eye display. In some examples, the display 104 may be configured to project light from a display source onto a portion of teleprompter glass functioning as a beam splitter seated at an angle (e.g., 30-45 degrees). The beam splitter may allow for reflection and transmission values that allow the light from the display source to be partially reflected while the remaining light is transmitted through. Such an optic design may allow a user to see both physical items in the world, for example, through the lenses 127, next to content (for example, digital images, user interface elements, virtual content, and the like) output by the display 104. In some implementations, waveguide optics may be used to depict content on the display 104.

In examples, the head mounted device 100 includes one or more of an audio output device 106 (such as, for example, one or more speakers), an illumination device 108, a sensing system 111, and an outward facing image sensor or camera 116. In examples, the head mounted device 100 may include a gaze tracking device 115 to detect and track eye gaze direction and movement. Data captured by the gaze tracking device 115 may be processed to detect and track gaze direction and movement as a user input.

In examples, the sensing system 111 may include various sensing devices, including but not limited to any combination of one or more optical proximity sensors, capacitive touch sensors, inertial measurement unit sensors, and pressure sensors. In examples, sensing system 111 may be positioned anywhere along one of arm portions 130.

In examples, sensing system 111 may include an optical proximity sensor. In examples, an optical proximity sensor may be located on one or each of arm portions 130. In examples, the optical proximity sensor may be located on other portions of headset 110.

In examples, sensing system 111 may include one or more capacitive touch sensors. In examples, a capacitive touch sensor may be located on one or each of arm portions 130. In some examples, one or more capacitive touch sensors may be located on other portions of the headset 110.

The sensing system 111 further includes a motion sensor, which may be implemented as an accelerometer, a gyroscope, and/or magnetometer, some of which may be combined to form an inertial measurement unit.

The sensing system 111 may further include a pressure sensor. The pressure sensor may be located on one or each of arm portions 130. In examples the pressure sensor may be positioned near a temple area of the arm portion. In other examples, the pressure sensor may be positioned anywhere along an arm portion.

In some examples, the head mounted device 100 may include a gaze tracking device 115 to detect and track eye gaze direction and movement. Data captured by the gaze tracking device 115 may be processed to detect and track gaze direction and movement as a user input. In the example shown in FIGS. 1B and 1C, the gaze tracking device 115 is provided in one of the two arm portions 130, simply for purposes of discussion and illustration. In the example arrangement shown in FIGS. 1B and 1C, the gaze tracking device 115 is provided in the same arm portion 130 as the display 104, so that user eye gaze can be tracked not only with respect to objects in the physical environment, but also with respect to the content output for display by the device 104. In some examples, gaze tracking devices 115 may be provided in each of the arm portions 130 to provide for gaze tracking of each of the two eyes of the user. In some examples, display 104 may be provided in each of the arm portions 130 to provide for binocular display of visual content.

FIG. 1D provides a view of the headset 110 of the head mounted device 100 in a neutral position, at-rest state, or a baseline state. In the neutral position of FIG. 1C, the arm portions 130, pivoting on the hinges 140, are unfolded out of the stow position but are not hyperextended outwards beyond the neutral position.

The hinges 140 are also operable to allow arm portions 130 to rotate inwards, thereby folding the headset 110 into a stowed position.

FIG. 1E depicts a view of the headset 110 of the head mounted device 100 with the arm portions 130 in a hyperextended position outward. In examples, headset 110 may be in this configuration when worn by a user. While a small amount of hyperextension of headset 110 may comprise a comfortable fit, too much hyperextension may be uncomfortable for the user. The present disclosure describes methods to generate a comfort prediction score that predicts when a user will find a fit of the headset 110 to be comfortable or uncomfortable so that the user can either work on better fitting headset 110 to their heads or get a different size of the headset 110 which might be more comfortable.

In FIG. 1E, the hyperextension may be seen in displacement A1 and A2 on opposing arm portion 130A and arm portion 130B, respectively. In examples, this may occur due to, for example, a mismatch between the size or geometry of the headset 110 and the head size and/or head shape of the user wearing the head mounted device 100. Deformation or deflection may cause discomfort due to, for example excess pressure between one or both of the arm portion(s) 130 of the headset 110. Further discomfort may be caused by excess warmth or heat which may be felt if any portion of the headset 110 is too close to the user's skin. In examples, one of displacement Al or A2 may be measured with an optical proximity sensor or a capacitance sensor. In further examples, however, both of displacements Al and A2 may be measured using a combination of two optical proximity or capacitance sensors. In examples, a pressure sensor may be used to measure pressure at one or both of arm portion 130A and arm portion 130B. In examples, the pressure measurement may comprise measuring a change of geometry in one or more of arm portions 130.

In examples hinges 140 may allow arm portions 130 to rotate outwards away from the center of the headset 110 when pressure is applied to the arm portions 130. In other examples, hinges 140 may not rotate outwards from a center of the headset 110, but the arm portions 130 may be compliant, thereby allowing the arm portions 130 to hyperextend outwards from a center of the headset 110 by bending when pressure is applied to the arm portions 130. In examples, headset 110 may include a combination of hinges 140 being extendable outward from the neutral position and arm portions 130 being compliant, thereby allowing the headset 110 to hyperextend outwards from the neutral position. When headset 110 extends outward from the neutral position when worn by a user, arm portions 130 may apply some degree of pressure on the user's head. A small amount of pressure may helpful for the fit of headset 110 to the user's head, but too much pressure may cause discomfort.

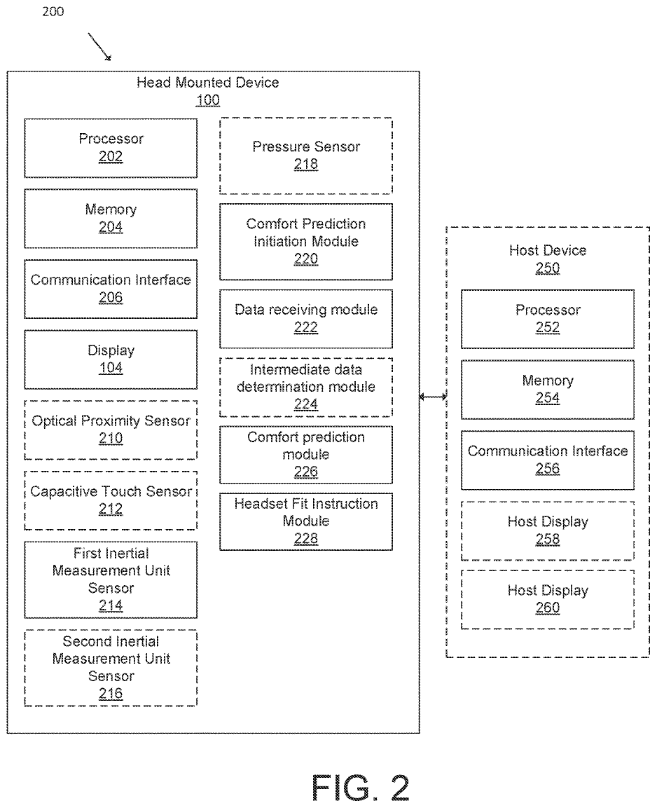

FIG. 2 depicts a block diagram of a system 200, according to an example. System 200 may provide for a determination of a predicted comfort score for the head mounted device 100 with respect to a user.

System 200 includes the head mounted device 100. The head mounted device 100 includes a processor 202, memory 204, communication interface 206, a display 104, a first inertial measurement unit 214, a comfort prediction initiation module 220, a data receiving module 222, a comfort prediction module 226, and a headset fit instruction module 228. In examples, the head mounted device 100 may further include any combination of: an optical proximity sensor 210, a capacitive touch sensor 212, a second inertial measurement unit 216, a pressure sensor 218, and an intermediate data determination module 224.

Head mounted device 100 includes a processor 202 and a memory 204. In examples, processor 202 may include multiple processors, and memory 204 may include multiple memories. Processor 202 may be in communication with any cameras, sensors, and other modules and electronics of head mounted device 100. Processor 202 is configured by instructions (e.g., software, application, modules, etc.) to display a visual representation of speech from a video or to facilitate the transfer of the display to another user device. The instructions may include non-transitory computer readable instructions stored in, and recalled from, memory 204. In examples, the instructions may be communicated to processor 202 from a computing device, for example host device 250, or from a network via a communication interface 206.

Processor 202 of head mounted device 100 is in communication with first inertial measurement unit sensor 214. Processor 202 may further be in communication with any combination of optical proximity sensor 210, capacitive touch sensor 212, second inertial measurement unit sensor 216, pressure sensor 218. Processor 202 may be configured by instructions to execute a predicted comfort model to generate a predicted comfort score. In examples, processor 202 may further be configured with instructions to generate a head fit instruction based on the predicted comfort score.

In examples, processor 202 may be configured to execute one or more machine learning models loaded from memory 204. In some examples, the models may be trained to receive one or more sensor inputs to generate a predicted comfort score for head mounted device 100 with respect to a user.

Communication interface 206 of head mounted device 100 may be operable to facilitate communication between head mounted device 100 and host device 250. In examples, communication interface 206 may utilize Bluetooth, Wi-Fi, Zigbee, or any other wireless or wired communication methods. In examples, communication interface 206 may be operable to communicate with a server over a network connection.

Display 104 may comprise see-through near eye display, as described above.

Head mounted device 100 may include a sensor operable to provide a measurement correlating to arm portion to skin distance. In examples, the sensor may be positioned in either of arm portion 130A or arm portion 130B. In examples, the sensor may determine the measurement based on the closest section of user skin to the sensor. In examples, the sensor may determine the measurement based on a section of user skin facing or proximate to the sensor.

In examples, head mounted device 100 may include optical proximity sensor 210 to provide an arm portion to skin distance measurement. Optical proximity sensor 210 may include a light source and a detector, using the reflected optical energy (or time of flight) to measure proximity of a skin to the sensor positioned in arm portion 130A or arm portion 130B of head mounted device 100.

In examples, head mounted device 100 may include capacitive touch sensor 212 operable to provide a measurement correlating to arm portion to skin distance.

Capacitive touch sensor 212 outputs capacitive readings when it is within a detectable distance of a user's skin. In examples, capacitive touch sensor 212 may be positioned to output capacitive readings when it is within a detectable distance of a user's temple.

In examples, head mounted device 100 may comprise other sensors operable to provide a measurement correlating to arm portion to skin distance.

Head mounted device 100 includes first inertial measurement unit sensor 214. In examples, first inertial measurement unit sensor 214 may be positioned anywhere along one of arm portions 130. First inertial measurement unit sensor 214 may be implemented as a three-axis motion sensor such as, for example, a three-axis accelerometer or a three-axis gyroscope, where the motion signals captured by the motion sensor describe three translation movements (i.e., x-direction, y-direction, and z-direction) along axes of a world coordinate system. In some examples, the motion sensor may be implemented as a six-axis motion sensor such as, for example, an inertial measurement unit that has six (6) degrees of freedom (6-DOF), which can describe three translation movements (i.e., x-direction, y-direction, and z-direction) along axes of a world coordinate system and three rotation movements (i.e., pitch, yaw, roll) about the axes of the world coordinate system.

In examples, first inertial measurement unit sensor 214 may be operable to provide a measure of displacement of one of arm portions 130 from its neutral position, for example as is depicted by arrows A1 or A2 in FIG. 1E. In examples, first inertial measurement unit sensor 214 may be operable to measure a tilt of one of arm portions 130. In examples, first inertial measurement unit sensor 214 may provide a tilt for one of arm portions 130 in an arcminute resolution. In examples, first inertial measurement unit sensor 214 may be operable to provide a motion or position of one of arm portions 130 in all axes.

In examples, head mounted device 100 may further include a second inertial measurement unit sensor 216. Second inertial measurement unit sensor 216 may be similar to first inertial measurement unit sensor 214. In examples, second inertial measurement unit sensor 216 may be positioned in an opposing arm portion across from first inertial measurement unit sensor 214, or in the same arm portion. In examples, second inertial measurement unit sensor 216 may be positioned on front frame portion 120.

In examples, head mounted device 100 may include pressure sensor 218. Pressure sensor 218 may be positioned at the temple area of arm portions 130, or along any portion of one of arm portions 130. Pressure sensor 218 may comprise a capacitive device comprising a two-plate structure operable to detect a squeeze between the plates. In examples, pressure sensor 218 may comprise a strain gauge sensor, a piezoelectric sensor, a barometric sensor, or any other type of pressure sensor. Pressure sensor 218 may be operable to detect a force applied against one of arm portions 130, a change in geometry of one of arm portions 130, or a deformation of one of arm portions 130 when head mounted device 100 is worn by a user. In examples, head mounted device 100 may include an instance of pressure sensor 218 in one or both of arm portions 130.

In examples, processor 202 of head mounted device 100 may be configured with instructions to execute comfort prediction initiation module 220. Comfort prediction initiation module 220 may be operable to initiate a comfort prediction determination for head mounted device 100 with respect to a user.

In examples, comfort prediction initiation module 220 may initiate generating a predicted comfort score upon determining that head mounted device 100 is being worn by a user. It may be determined that a user is wearing head mounted device 100 using, for example, one or more position sensors such as optical proximity sensor 210 or capacitive touch sensor 212. In examples, comfort prediction initiation module 220 may determine that a user is powering up head mounted device 100 for the first time. In examples, a user may be powering up head mounted device 100 as part of an unboxing procedure. In examples, comfort prediction initiation module 220 may initiate generating a predicted comfort score upon determining that a user is pairing head mounted device 100 with a host device for the first time, for example with host device 250. In examples, comfort prediction initiation module 220 may initiate generating a predicted comfort score upon determining that a new user is wearing head mounted device 100 for the first time because that user is creating a new user profile. In further examples, comfort prediction initiation module 220 may initiate generating a predicted comfort score for other reasons related to identifying a need to determine whether head mounted device 100 fits a user or not.

In examples, processor 202 of head mounted device 100 may be configured with instructions to execute data receiving module 222. Data receiving module 222 is operable to receive data from one or more sensors associated with head mounted device 100. Data receiving module 222 may also be operable to receive data from one or more other devices, such as host device 250.

Data receiving module 222 is operable to receive a first measurement from a sensor indicating an arm portion to skin distance. For example, the first sensor may be one or more of optical proximity sensor 210 and capacitive touch sensor 212. In examples, the first measurement may include a distance measurement between at least one of arm portions 130 and a user's skin. In examples, the first measurement may represent a distance between one of arm portions 130 and the temple area of a user's head. In examples, the first measurement may include raw data correlating to the distance between at least one of arm portions 130 and a user's skin.

Data receiving module 222 may be further operable to receive a second measurement from first inertial measurement unit 214 indicating an arm portion orientation. In examples, the second measurement may comprise an orientation of arm portion 130A or arm portion 130B with respect to 3D space. In examples, the second measurement may comprise an orientation of arm portion 130A or arm portion 130B with respect to front frame portion 120. In examples, the second measurement may comprise an orientation of arm portion 130A or arm portion 130B with respect to the other of arm portion 130A or arm portion 130B. In examples, the second measurement may include a deformation angle of one of arm portions 130 away from a neutral position, as portrayed in FIG. 1D. In examples, the second measurement may be measured in arcminutes. In further examples, the second measurement may include raw data correlating to the distance between at least one of the arm portions 130 and the user's skin.

In examples, data receiving module 222 may be further operable to receive a third measurement from second inertial measurement unit 216. In examples, first inertial measurement unit sensor 214 may be positioned on arm portion 130A opposing arm portion 130B where second inertial measurement unit sensor 216 is positioned. In examples, first inertial measurement unit sensor 214 may be positioned on front frame portion 120.

In examples, the second and third measurements may be used to determine the angle of one of arm portion 130A or arm portion 130B with respect to front frame portion 120 or with respect to a neutral arm portion position. In examples, the second and third measurements may be used to determine the angle of arm portion 130A and arm portion 130B to one another.

In examples, head mounted device 100 may include a third inertial measurement unit sensor (not depicted). For example, first inertial measurement unit sensor 214 may be positioned on a first of arm portion 130A or arm portion 130B, second inertial measurement unit sensor 216 may be positioned on front frame portion 120, and the third inertial measurement unit sensor may be positioned on the second of arm portion 130A or arm portion 130B. The first, second, and third inertial measurement unit sensors may be used to determine the orientations of arm portions 130 with respect to front frame portion 120 and one another. The first, second, and third inertial measurement unit sensors may be further used to determine any other possible deformation of headset 110.

In examples, data receiving module 222 may be further operable to receive a fourth measurement from pressure sensor 218. The fourth measurement may comprise a pressure measurement or raw data correlating to a pressure measurement representing a force on one of arm portions 130.

In examples, data receiving module 222 may receive an image of a user face. For example, data receiving module 222 may receive an image of a user face from host device 250. In examples, host device 250 may prompt the user to take a selfie photo during, for example, an unboxing event or a pairing event between head mounted device 100 and host device 250. In examples, host device 250 may then send the image to head mounted device 100 for further processing.

In examples, processor 202 of head mounted device 100 may be configured with instructions to execute intermediate data determination module 224. Intermediate data determination module 224 may be configured with instructions to determine a hinge rotation based on the second measurement and the third measurement. For example, if first inertial measurement unit sensor 214 is positioned in one of arm portions 130 and second inertial measurement unit sensor 216 is positioned on front frame portion 120, it may be possible to determine the hinge rotation by comparing the second measurement and the third measurement. In examples, the hinge rotation may be the angular position of the hinge with respect to headset 110. In examples, the hinge rotation may be the angular position of the hinge with respect to the neutral position described with respect to FIG. 1D.

In examples, intermediate data determination module 224 may be operable to determine a user face feature based on the image. For example, intermediate data determination module 224 may determine that a user has a long, narrow, or wide face. Intermediate data determination module 224 may determine that a user has a narrow or a wide nose or identify a nose bridge location. In examples, intermediate data determination module 224 may determine the location of a user's ears with respect to their nose. In further examples, intermediate data determination module 224 may determine any other facial feature based on the image that may be relevant to generating a predicted comfort score for head mounted device 100 with respect to a user.

In examples, processor 202 of head mounted device 100 may be configured with instructions to execute comfort prediction module 226. Comfort prediction module 226 may execute a comfort prediction model comprising a machine learned model trained, e.g., using supervised or semi-supervised training. The comfort prediction model may use the first measurement and the second measurement as inputs to generate a predicted comfort score.

The predicted comfort score corresponds to a scale or index predicting how comfortable head mounted device 100 is likely to be for a particular user. In examples, the predicted comfort score may represent a regression score. In examples, the predicted comfort score may be scaled from 1 to 100. In examples, the predicted comfort score may be a percentage. For example, if the predicted comfort score is determined to be above 95%, this may indicate that head mounted device 100 is likely to be very comfortable, and therefore probably a good fit for a user.

In examples, the predicted comfort score may represent a prediction regarding the pressure comfort of head mounted device 100 for the user. In examples, the predicted comfort score may represent a prediction regarding the thermal comfort of head mounted device 100 for the user. In examples, the predicted comfort score may represent a combination of predicted pressure and thermal comfort of head mounted device 100 for the user.

In examples, executing comfort prediction module 226 may use the third measurement as input to the comfort prediction model. In examples, executing comfort prediction module 226 may use the hinge rotation as input to the comfort prediction model. In examples, executing comfort prediction module 226 may use the fourth measurement as input to the comfort prediction model. In examples, executing comfort prediction module 226 may use the user face feature as input to the comfort prediction model. In examples, comfort prediction module 226 may use any combination of the third measurement, hinge rotation, fourth measurement, or user face feature as input to the comfort prediction model to generate the predicted comfort score.

In examples, processor 202 of head mounted device 100 may be configured with instructions to execute headset fit instruction module 228. Headset fit instruction module 228 may generate, based on the comfort prediction score, a trigger signal indicating whether a position of the worn head mounted device 100 is to be adjusted or not. This trigger signal may, for example, include generating an indication to display a headset fit instruction based on the comfort prediction score. Generally, the generated trigger signal may result in a visual and/or audible output informing about whether head mounted device 100 is predicted to be comfortable for a user or whether head mounted device 100 is more likely to apply too much pressure or heat to the user's head, resulting in discomfort. Thereby, an visual and/or audible output may be automatically generated informing the user when further fitting or steps may be advised to achieve a comfortable fit that will not apply excess pressure or warming to the user's skin. In examples, the indication may be received at head mounted device 100 and the headset fit instruction may be displayed on display 104. In further examples, however, the indication may be received at host device 250 and the headset fit instruction may be displayed on a host display 258 of host device 250.

In examples, the headset fit instruction may comprise instructions for the user to do at least one of: make adjustments to the headset, request fit help from a professional, exchange the headset for a different size, or wear the headset as is. When the predicted comfort score indicates that head mounted device 100 may not be comfortable for a user, the headset fit instructions may offer advice for how to either change the fit to make it more comfortable. If the headset fit instruction directs the user to make adjustments to the headset, the user may be instructed to do any combination of: adjust a nose pad, loosen at least one hinge connecting front frame portion 120 to arm portions 130, or adjust the bend between at least one of arm portions 130 and the temple tips to change how headset 110 fits around one or both ears. In examples, the headset fit instruction may instruct a user to go to an optometrist for professional help fitting headset 110. In examples, the headset fit instructions may advise the user to return head mounted device 100 and order a different size.

In examples when the predicted comfort score indicates that it should be comfortable for a user, the headset fit instructions may indicate that head mounted device 100 fits correctly. The headset fit instruction may also comprise instructions for the user which measures are to be taken to achieve a fit of head mounted device 100 that will be less likely to produce discomfort. The user may thus be informed how to achieve a more optimal fit or positioning of the particular head mounted device 100 on his/her head.

In examples, the system 200 may further include a host device 250. Host device 250 may comprise a smart phone, handheld device, a laptop, desktop computer, a wearable device, or any other device operable to pair with head mounted device 100. Host device 250 includes a processor 252, memory 254, and communication interface 256. In examples, the host device 250 may further include a host display 258 and a host camera 260.

In examples, host device 250 may be paired with head mounted device 100. In examples, host device 250 may execute any portion of comfort prediction initiation module 220, data receiving module 222, intermediate data determination module 224, comfort prediction module 226, or headset fit instruction module 228. In examples, host device 250 may execute part of an unboxing procedure for head mounted device 100 and/or used to display headset fit instructions.

In examples, processor 252 and memory 254 of host device 250 may be similar to processor 202 and memory 204 of head mounted device 100 described above.

Communication interface 256 of host device 250 may be operable to facilitate communication between head mounted device 100 and host device 250 via any communication protocol described above with respect to communication interface 206. In examples, communication interface 256 may be operable to communicate with a server over a network connection.

Host display 258 of host device 250 may comprise a smartphone display, a laptop display, a monitor, a wearable device display, or any other type of display.

Host camera 260 may comprise a smartphone camera, a web camera, a laptop camera, or any other type of camera operable to be paired or connected with host camera 260. In examples, host camera 260 may be used to take a picture of a user's face which may be used as an input to the comfort prediction model to determine the predicted comfort score for head mounted device 100.

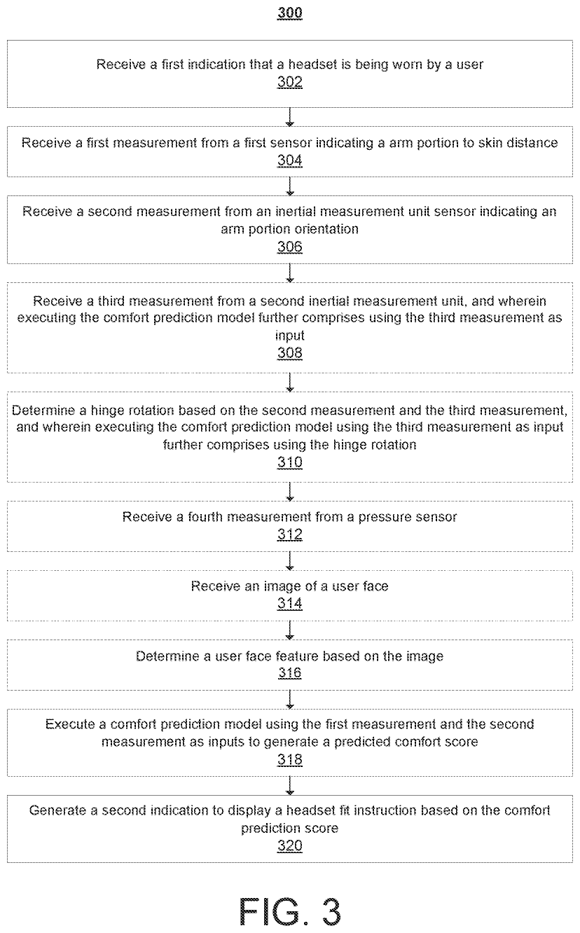

FIG. 3 depicts method 300, according to an example. Method 300 may be used to determine a predicted comfort score for a headset of a head mounted device. In examples, method 300 may be executed on any combination of head mounted device 100 and host device 250. Method 300 may include any combination of steps 302 to 320.

Method 300 begins with step 302. In step 302, a first indication is received that a headset is being worn by a user. In examples, the first indication may be received at comfort prediction initiation module 220, as described above.

Method 300 continues with step 304. In step 304, the first measurement is received from a first sensor indicating an arm portion to skin distance. For example, the first measurement may be received at data receiving module 222, as described above.

Method 300 continues with step 306. In step 306, a second measurement from an inertial measurement unit sensor is received indicating an arm portion orientation. For example, the second measurement may be received at data receiving module 222, as described above.

Method 300 continues with step 318. In step 318, a comfort prediction model is executed using the first measurement and the second measurement as inputs to generate a predicted comfort score. For example, the comfort prediction model may be executed in comfort prediction module 226, as described above.

Method 300 continues with step 320. In step 320, a second indication is generated to display a headset for instruction based on the comfort prediction score. For example, the second indication may be generated in headset fit instruction module 228, as described above.

In examples, method 300 may further include step 308. In step 308, a third measurement may be received from a second inertial measurement unit and executing the comfort prediction model may further comprise using the third measurement is input. For example, the third measurement may be received at data receiving module 222, and comfort prediction module 226 may use the third measurement as an input to the comfort prediction model, as described above.

In examples, method 300 may further include step 310. In step 310, a hinge rotation may be determined based on the second measurement and the third measurement and executing the comfort prediction model using the third measurement as input may further comprise using the hinge rotation. For example, the hinge rotation may be determined by intermediate data determination module 224, as described above.

In examples, method 300 may further include step 312. In step 312, a fourth measurement may be received from a pressure sensor. For example, the fourth measurement may be received by data receiving module 222, as described above.

In examples, method 300 may further include step 314. In step 314, an image may be received of a user face. For example, an image may be received by data receiving module 222, as described above.

In examples, method 300 may further include step 316. In step 316, a user face feature may be determined based on the image. For example, intermediate data determination module 224 may determine the user face feature, as described above.

In some aspects, the techniques described herein relate to a method, wherein the sensor is a proximity sensor or a capacitive touch sensor.

In some aspects, the techniques described herein relate to a method, wherein the inertial measurement unit is a first inertial measurement unit, the method further including: receiving a third measurement from a second inertial measurement unit, and wherein executing the comfort prediction model further includes using the third measurement as input.

In some aspects, the techniques described herein relate to a method, further including: determining a hinge rotation based on the second measurement and the third measurement, and wherein executing the comfort prediction model using the third measurement as input further includes using the hinge rotation.

In some aspects, the techniques described herein relate to a method, further including: receiving a fourth measurement from a pressure sensor, and wherein executing the comfort prediction model further includes using the fourth measurement as input to generate the predicted comfort score.

In some aspects, the techniques described herein relate to a method, further including: receiving an image of a user face; and determining a user face feature based on the image, and wherein executing the comfort prediction model further includes using the user face feature as input to generate the predicted comfort score.

In some aspects, the techniques described herein relate to a method, wherein the headset fit instruction includes instructions for the user to do at least one of: make adjustments to the headset, request fit help from a professional, exchange the headset for a different size, or wear the headset as is.

In some aspects, the techniques described herein relate to a method, wherein the predicted comfort score includes a pressure comfort score.

In some aspects, the techniques described herein relate to a head mounted device, wherein sensor is a proximity sensor or a capacitive touch sensor.

In some aspects, the techniques described herein relate to a head mounted device, wherein the processing circuitry is further configured to: receive a third measurement from a second inertial measurement unit, and wherein executing the comfort prediction model further includes using the third measurement as input.

In some aspects, the techniques described herein relate to a head mounted device, wherein the processing circuitry is further configured to: determine a hinge rotation based on the second measurement and a third measurement, and wherein executing the comfort prediction model using the third measurement as input further includes using the hinge rotation.

In some aspects, the techniques described herein relate to a head mounted device, wherein the processing circuitry is further configured to: receive a fourth measurement from a pressure sensor, and wherein executing the comfort prediction model further includes using the fourth measurement as input to generate the predicted comfort score.

In some aspects, the techniques described herein relate to a head mounted device, wherein the processing circuitry is further configured to: receive a user face shape, and wherein executing the comfort prediction model further includes using the user face shape as input to generate the predicted comfort score.

In some aspects, the techniques described herein relate to a head mounted device, wherein the headset fit instruction includes instructions for the user to do at least one of: make adjustments to the headset, request fit help from a professional, exchange the headset for a different size, or wear the headset as is.

In some aspects, the techniques described herein relate to a head mounted device, wherein the predicted comfort score includes a pressure comfort score.

In some aspects, the techniques described herein relate to a system, wherein the sensor is a proximity sensor or a capacitive touch sensor.

In some aspects, the techniques described herein relate to a system, wherein the data receiving module is further configured to receive a third measurement from a second inertial measurement unit, and the comfort prediction module is further configured to execute the comfort prediction model further includes using the third measurement as input.

In some aspects, the techniques described herein relate to a system, further including: an intermediate data determination module configured to determine a hinge rotation based on the second measurement and the third measurement, and wherein executing the comfort prediction model using the third measurement as input further includes using the hinge rotation.

In some aspects, the techniques described herein relate to a system, wherein the data receiving module is further configured to receive a fourth measurement from a pressure sensor, and the comfort prediction module is further configured to use the fourth measurement as input to generate the predicted comfort score.

In some aspects, the techniques described herein relate to a system, wherein the data receiving module is further configured to receive a user face shape, and the comfort prediction module is further configured to use the user face shape as input to generate the predicted comfort score.

In some aspects, the techniques described herein relate to a system, wherein the headset fit instruction module further includes instructions for the user to do at least one of: make adjustments to the headset, request fit help from a professional, exchange the headset for a different size, or wear the headset as is.

In some aspects, the techniques described herein relate to a system, wherein the predicted comfort score includes a pressure comfort score.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising,
receiving a first indication that wearable display device is being worn, the wearable display device including a headset with a first arm and a second arm;
receiving a first measurement from a sensor indicating an arm to skin distance;
receiving a second measurement from an inertial measurement unit indicating an arm orientation;
executing a model using the first measurement and the second measurement as inputs to generate a score indicating comfort; and
generating a second indication to display an instruction to fit the headset based on the score.

2. The method of claim 1, wherein the sensor is a proximity sensor or a capacitive touch sensor.

3. The method of claim 1, wherein the inertial measurement unit is a first inertial measurement unit, the method further comprising:
receiving a third measurement from a second inertial measurement unit, and wherein executing the model further comprises using the third measurement as input.

4. The method of claim 3, further comprising:
determining a rotation of a hinge based on the second measurement and the third measurement, and wherein executing the model using the third measurement as input further comprises using the rotation.

5. (canceled)

6. The method of claim 1, further comprising:
receiving an image of a face; and
determining a facial feature based on the image, and wherein executing the model further comprises using the user facial feature as input to generate the score.

7. The method of claim 1, wherein the instruction comprises at least one of: making adjustments to the headset, requesting fit help from a professional, exchanging the headset for a different size, or wearing the headset as is.

8. (canceled)

9. A wearable display device comprising:
a headset a front frame and a second arm;
a sensor operable to provide a first measurement indicating an arm to skin distance;
an inertial measurement unit operable to provide a second measurement indicating an arm orientation;
a memory; and
a processing circuitry coupled to the memory, the processing circuitry being configured to:
receive a first indication that the headset is being worn,
receive the first measurement,
receive the second measurement,
execute a model using the first measurement and the second measurement as inputs to generate a score indicating comfort, and
generate a second indication to display an instruction to fit the headset based on the score.

10. The wearable display device of claim 9, wherein sensor is a proximity sensor or a capacitive touch sensor.

11. The wearable display device of claim 9, wherein the processing circuitry is further configured to:
receive a third measurement from a second inertial measurement unit, and wherein executing the model further comprises using the third measurement as input.

12. The wearable display device of claim 11, wherein the processing circuitry is further configured to:
determine a rotation of a hinge based on the second measurement and a third measurement, and wherein executing the model using the third measurement as input further comprises using the rotation.

13. The wearable display device of claim 9, wherein the processing circuitry is further configured to:
receive a fourth measurement from a pressure sensor, and wherein executing the model further comprises using the fourth measurement as input to generate the score.

14. The wearable display device of claim 9, wherein the processing circuitry is further configured to:
receive a facial feature, and wherein executing the model further comprises using the facial feature as input to generate the score.

15. The wearable display device of claim 9, wherein the instruction comprises at least one of: making adjustments to the headset, requesting fit help from a professional, exchanging the headset for a different size, or wearing the headset as is.

16. (canceled)

17. A system comprising:
a first module configured to receive a first indication that a headset is being worn, the headset comprising a first arm and a second arm;
a second module configured to receive a first measurement from a sensor indicating an arm to skin distance, and a second measurement from an inertial measurement unit sensor indicating an arm orientation;
a third module configured to execute a model using the first measurement and the second measurement as inputs to generate a score indicating comfort; and
a fourth module configured to generate a second indication to display an instruction to fit the headset based on the score.

18. The system of claim 17, wherein the sensor is a proximity sensor or a capacitive touch sensor.

19. The system of claim 17, wherein the second module is further configured to receive a third measurement from a second inertial measurement unit, and the third module is further configured to execute the model uses the third measurement as input.

20. The system of claim 19, further comprising:
an fifth module configured to determine a hinge rotation of a hinge based on the second measurement and the third measurement, and wherein executing the model using the third measurement as input further comprises using the rotation.

21. The system of claim 17, wherein the second module is further configured to receive a fourth measurement from a pressure sensor, and the third module is further configured to use the fourth measurement as input to generate the score.

22. The system of claim 17, wherein the second module is further configured to receive a facial feature, and the third module is further configured to use the facial feature as input to generate the score.

23. The system of claim 17, wherein the fourth module further comprises at least one of: making adjustments to the headset, requesting fit help from a professional, exchanging the headset for a different size, or wearing the headset as is.

24. (canceled)
